(19) United States
(12) Patent Application Publication
(10) Pub. No.: US 2010/0086187 A1
(43) Pub. Date: Apr. 8, 2010

(54) SYSTEM AND METHOD FOR FLEXIBLE RATE PROCESSING OF ULTRASOUND DATA

(76) Inventor: James Hamilton, Brighton, MI (US)

Correspondence Address: SCHOX PLC, 500 3rd Street, Suite 515, San Francisco, CA, 94107, US

(21) Appl. No.: 12/565,662

(22) Filed: Sep. 23, 2009

Related U.S. Application Data
(60) Provisional application No. 61/099,484, filed on Sep. 23, 2008.

(51) Int. Cl. G06K 9/00

(52) U.S. Cl. 382/131

(57) ABSTRACT

The invention is directed at a method and system for flexible rate processing of ultrasound data. In one embodiment, the method includes acquiring ultrasound data at a data acquisition rate; setting an inter-frameset data rate; selecting frames from acquired ultrasound data to form a plurality of framesets, where the framesets are spaced according to the inter-frameset data rate; and processing the data at the controlled data rates. In another embodiment, the system includes a data acquisition controller that collects ultrasound data at an acquisition rate; a memory that stores the ultrasound data; and a data processor that selects framesets at an inter-frameset data rate, wherein a frameset is a set of frames selected from memory, performs processing on a frameset, and outputs processed data at a product rate.

### CROSS-REFERENCE TO RELATED APPLICATIONS

This application claims the benefit of U.S. Provisional Application No. 61/099,484, filed on 23 Sep. 2008, which is incorporated in its entirety by this reference.

### STATEMENT REGARDING FEDERALLY SPONSORED RESEARCH OR DEVELOPMENT

This invention was supported by a grant from the National Heart, Lung, and Blood Institute (#5R44HL071379), and the U.S. government may therefore have certain rights in the invention.

### TECHNICAL FIELD

This invention relates generally to the ultrasound field, and more specifically to a new and useful system and method for flexible rate processing of ultrasound data in the ultrasound field.

### BACKGROUND

Ultrasound based speckle tracking is a useful tool for accurately measuring tissue motion and deformation, and has provided significant advances for applications such as breast elastography and cardiac strain rate imaging. However, clinical impact and widespread use has been limited because the majority of methods are not real-time. This is primarily due to the large computational and data communication resources needed for real-time ultrasound speckle-tracking.

Speckle tracking calculates the motion of ultrasound image components (‘speckles’) between two or more frames (called a frameset). Speckles are produced by ultrasound signal scattering from tissue. In this case, a frame refers to a region or regions of tissue imaged at a particular time (or time period). The time between frames (i.e., inverse frame rate) and the tissue motion primarily determine the performance and requirements of speckle tracking algorithms. For example, high tissue velocity and low frame rates result in large inter-frame motion, which increases the search range needed for speckle tracking. The increased search region can significantly impact system design and computational resources. In addition, large inter-frame deformation can produce speckle decorrelation, reducing the accuracy of speckle tracking results. Processes such as speckle tracking need high spatial and temporal resolution, which only further increases the processing requirements. Thus, there is a need in the ultrasound field to create a new and improved system and method for flexible rate processing of ultrasound data. This invention provides such a new and useful system and method.

### SUMMARY

The invention is directed at a method and system for flexible rate processing of ultrasound data. In one embodiment of the invention, the method includes acquiring ultrasound data at a data acquisition rate; setting an inter-frameset data rate; selecting frames from acquired ultrasound data to form a plurality of framesets, where the framesets are spaced according to the inter-frameset data rate; and processing the data at the controlled data rates. In another embodiment, the system includes a data acquisition controller that collects ultrasound data at an acquisition rate; a memory that stores the ultrasound data; and a data processor that selects framesets at an inter-frameset data rate, wherein a frameset is a set of frames selected from memory, performs processing on a frameset, and outputs processed data at a product rate. Both the method and system collect ultrasound data at an acquisition rate, while process framesets at an inter-frameset data rate. Thus, the acquisition and processing rates are functionally decoupled by organizing data into framesets. In one application of the invention, the method and system are used for computationally expensive processing operations, such as speckle tracking, in real-time.

### BRIEF DESCRIPTION OF THE FIGURES

FIG. 1 is a flowchart diagram of the preferred method of the invention.

FIG. 2 is a block diagram overview of adjustable data rate processing architecture.

FIG. 3 is a schematic of the decoupling of the acquisition rate and the processing rate using a data buffer using controlled data retrieval to select framesets passed to the data processor from a time series of acquired frames.

### DESCRIPTION OF THE PREFERRED EMBODIMENTS

The following description of the preferred embodiments of the invention is not intended to limit the invention to these preferred embodiments, but rather to enable any person skilled in the art to make and use this invention.
1. Method for Flexible Rate Processing of Ultrasound Data

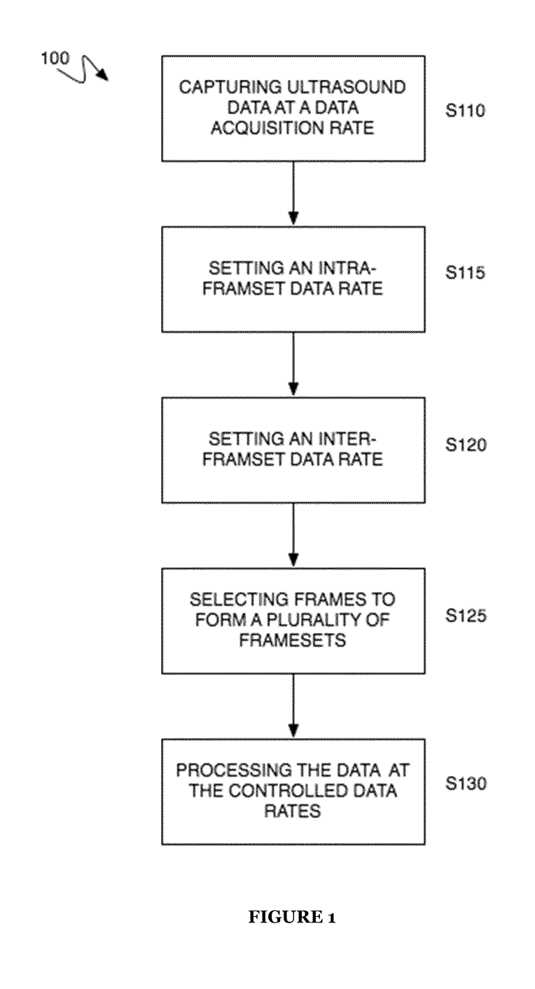

As shown in FIGS. 1-3, the preferred method 100 of the invention for flexible rate processing of ultrasound data includes capturing ultrasound data at a data acquisition rate S110, setting an inter-frameset data rate S120, selecting frames to form a plurality of framesets S125, and processing the data from memory at the controlled data rates S130. The preferred method of the invention may also include the step of setting an intra-frameset data rate S115. The method 100 functions to allow high frame rate data (the acquisition data rate) to be displayed or processed according to a second data rate (the inter-frameset data rate). The framesets are preferably selections of frames at a rate necessary for a processing operation, and the framesets are preferably spaced according to the inter-frameset data rate such that display or other operations (with different frame rate requirements) can be sufficiently performed. Additionally, the processing preferably occurs on raw or unprocessed ultrasound data, but may alternatively occur on pre-processed ultrasound data. Detailed analysis, additional processing, slow motion playback, fast motion playback, and/or other operations can be performed on the ultrasound data, assuming the ultrasound data is stored in memory, while still providing real-time display. While the preferred method is focused on ultrasound speckle tracking, it can also be applied to other ultrasound imaging modes in cases where decoupling of processing from acquisition rates or dynamic processing rates are desired. In one example, performing a processing task requiring data at 100 frames per second data and displaying the output at 30 frames per second, the processing requirements can be reduced to less than a third of full processing requirements without sacrificing the quality of results.

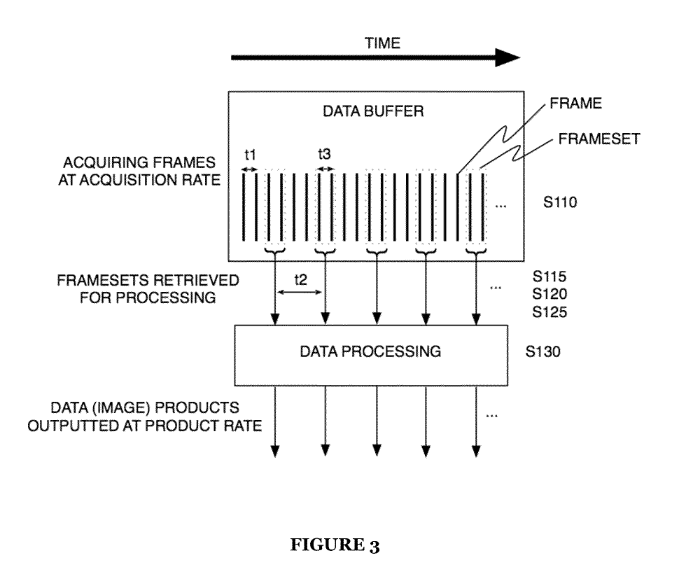

Step S110, which includes capturing ultrasound data at a data acquisition rate, functions to capture ultrasound data at a rate high enough to enable speckle tracking. The data acquisition rate preferably determines the time between collected ultrasound frames as indicated by t1 in FIG. 3. For example, accurate speckle tracking of the large deformation rates associated with cardiac expansion and contraction (i.e., peak strain rates of ˜2 Hz) requires frame rates preferably greater than 100 frames per second. This frame rate is approximately 3 times greater than the frame rate needed for real-time visualization at 30 frames per second. In most cases, the frame rate required for accurate speckle tracking is greater than the frame rate needed for real-time visualization rates. The characteristics of bulk tissue motion determine visualization rates, in contrast to the interaction of ultrasound with tissue scatterers, which determines speckle-tracking rates (also referred to as intra-frameset rates). The data acquisition rate may be set to any suitable rate according to the technology limits or the data processing requirements. Maximum visualization rates are limited by human visual perception, around 30 frames per second. However, lower visualization rates may be suitable, as determined by the details of the tissue motion (e.g., tissue acceleration).

Step S120, which includes setting an inter-frameset data rate, functions to select (or sample) the frames comprising the frameset from the acquired data according to a pre-defined rate. The inter-frameset data rate is defined as time between processed framesets as indicated by t2 in FIG. 3. Upon setting the inter-frameset data rate, Step S120 preferably includes selecting frames from acquired ultrasound data to form a plurality of framesets S125. Step S125 functions to form the framesets for processing. The framesets are preferably spaced according to the inter-frameset data rate and any suitable parameters of the framesets. The inter-frameset data rate is preferably set to the desired output data rate such as the display rate. The inter-frameset data rate is less than or equal to the data acquisition rate. The inter-frameset data rate is preferably an integer factor of the data acquisition rate, but is otherwise preferably independent of the data acquisition rate. The acquisition rate sets the maximum rate of the inter-frameset sampling. Additionally or alternatively, parameters of the framesets may be set according to the needs of the processing step S130 or any suitable requirement. The parameters are preferably the inter-frameset data rate, but may alternatively include intra-frameset data rate, the number of frames, the number of framesets, timing of frames or framesets (such as nonlinear spacing), trigger events (from other physiological events), data compression, data quality, and/or any suitable parameter of the frameset. In one variation, the inter-frameset data rate is dynamically adjusted during acquisition, preferably according to physiological motion, to better track the relative motion of the tissue (i.e. a shorter time between framesets for large tissue motion and acceleration, and a longer time between framesets for small tissue motion). In the example shown in FIG. 3, the frameset rate (or output product rate) is one fourth (¼) of the acquisition rate.

Step S130, which includes processing the data from memory at the controlled data rates, functions to perform speckle tracking of features in the framesets. The processing is preferably individually performed on a frameset of frames. The framesets are preferably processed sequentially according to the inter-frameset data rate. The controlled data rates are preferably understood to include any set data rates governing the data rate passed to the processor, such as processing framesets at an inter-frameset data rate, processing frames of a frameset at an intra-frameset data rate, and optionally, outputting data at a product data rate. The speckle tracking is preferably performed on a frameset of two or more frames. The speckle tracking preferably processes at least at rates adequate for visualization (e.g., 30 framesets per second), but a higher or lower frame rate may alternatively be used for other applications and requirements. For example, machine vision algorithms may require higher visualization data rates. Lower visualization data rate can be used for long term monitoring or event detection. Alternatively, any suitable processing operation may be performed such as interpolation. The processing operation preferably requires a higher frame rate than the final desired output data rate. Data is preferably output after the processing of data at a product rate. The product rate is preferably equal to the inter-frameset data rate but may alternatively be different from the inter-frameset data rate depending on the processing operation.

The preferred method also includes step S115, which includes setting an intra-frameset data rate. Step S115 functions to adjust the time between frames within a frameset as indicated by t3 in FIG. 3. The time between frames of the frameset is limited by the acquisition rate. However, while a frameset preferably comprises a pair of sequentially acquired frames, the frameset may alternatively comprise a pair of non-sequentially acquired frames acquired at the data acquisition rate (i.e. every other frame acquired at the data acquisition rate). The acquisition rate sets the maximum rate of the intra-frameset sampling. However, a variable intra-frameset data rate may be used, preferably according to physiological motion, to optimize speckle tracking performance (i.e. shorter time between frames with quickly changing speckle and longer time between frames for slowly changing speckle). The intra-frameset sampling data rate is preferably a multiple of the data acquisition rate, but is otherwise independent of the data acquisition rate. Also in the example shown in FIG. 3, the frameset is a pair of sequentially acquired frames, and so the time between the frames of the frameset is the time between acquired frames and the intra-frameset rate is determined to be the data acquisition rate.

An alternative embodiment preferably implements the above method in a computer-readable medium storing computer-readable instructions. The instructions are preferably executed by computer-executable components for acquiring and processing ultrasound data. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.
2. System for Flexible Rate Processing of Ultrasound Data

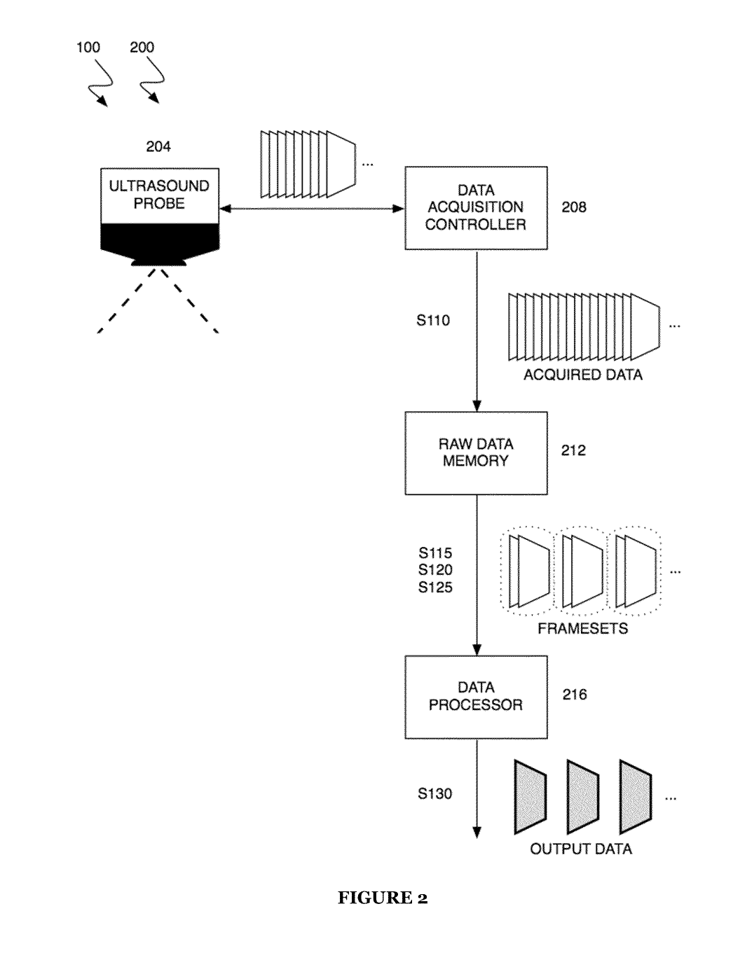

As shown in FIGS. 2-3, a system 200 for flexible rate processing of ultrasound data includes an ultrasound probe 204 that functions to transmit and detect the acoustic signals, a data acquisition controller 208 that controls the ultrasound probe 204 and calculates the raw image data, a memory 212, and a data processor 216. The ultrasound probe 204 may alternatively be an outside device or even stored ultrasound data that interfaces with the data acquisition controller 208. Like the previous method, this system decouples the acquisition and processing rates, which affords greater flexibility in design of the system processing architecture. Using this adjustable processing method for the previously mentioned cardiac example, speckle tracking of frame pairs can be performed at 30 pairs per second, providing adequate rate for visualization. A fast acquisition rate is still needed (100 frames per second or greater) to provide the short time between the frames of the frameset selected for speckle tracking. In contrast, traditional pipelined processing (i.e., processing all frames) would require a 3× increase in speckle tracking computations, since a processing rate of 100 frame pairs per second is needed, in order to match the acquisition rate.

The memory 212 of the preferred embodiment functions to store the raw data collected from the ultrasound probe 204 and data acquisition controller 208. The memory 212, or raw data buffer, preferably contains the frames stored at the acquisition rate. The raw data buffer is preferably stored temporarily, but may be stored long-term or permanently for further post processing, event recall (such as capturing a heart flutter), video recording, or any other suitable purpose.

The data processor 216 of the preferred embodiment functions to read a frameset from the memory 212 and is adapted to process the framesets at a controllable rate, called the processing rate. The data processor 216 preferably selects framesets at an inter-frameset data rate (or processing rate). The framesets are preferably a set of frames selected from memory 212. The inter-frameset rate is preferably less than or equal to the acquisition rate. The processor 216 preferably performs processing, such as speckle tracking, interpolation, and/or other processing, on the framesets. As shown in FIG. 3, framesets (pairs are shown, but any suitable number of frames may be included in a frameset) are preferably selected (as indicated by the braces in FIG. 3) from the set of frames stored in the memory 212 for data processing in the data processor 216. The data processor 216 may additionally select frames of a frameset at an intra-frameset data rate, which functions to set the spacing of frames in the processed frameset. In this case, a frameset is selected, two frames are skipped and the process is repeated. The inter-frameset data rate and/or the intra-frameset data rate may be adjusted according to physiological motion, to better track the relative motion of the tissue. The data processor 216 additionally outputs processed data at a product rate. The output product rate (which may directly translate into the visualization rate if used for visualization, but may alternatively be an output rate for another suitable analytical purpose) from the data processor 216 is preferably equal to the frameset rate.

As a person skilled in the art will recognize from the previous detailed description and from the figures and claims, modifications and changes can be made to the preferred embodiments of the invention without departing from the scope of this invention defined in the following claims.

We claim:

1. A method for flexible rate processing of ultrasound data comprising:
acquiring ultrasound data at a data acquisition rate;
setting an inter-frameset data rate;
selecting frames from acquired ultrasound data to form a plurality of framesets, wherein the framesets are spaced according to the inter-frameset data rate; and
processing the data at the controlled data rates.

2. The method of claim 1, wherein processing of data is performed on a frameset of frames.

3. The method of claim 2, further including outputting data at the inter-frameset data rate.

4. The method of claim 2, wherein the acquisition data rate is greater than the inter-frameset data rate.

5. The method of claim 4, wherein the inter-frameset data rate is an integer factor of the acquisition data rate.

6. The method of claim 2, wherein the frameset has at least two frames.

7. The method of claim 6, wherein the at least two frames are consecutive frames of the acquired ultrasound data.

8. The method of claim 2, further comprising setting an intra-frameset data rate and selecting frames of a frameset according to the intra-frameset data rate.

9. The method of claim 8, wherein the intra-frameset data rate equals the acquisition data rate.

10. The method of claim 2, wherein parameters of the framesets are set according to a requirement of the processing step.

11. The method of claim 10, wherein the operation is speckle tracking.

12. The method of claim 10, further comprising dynamically adjusting the inter-frameset data rate.

13. The method of claim 12, further comprising dynamically adjusting the intra-frameset data rate.

14. The method of claim 13, wherein the adjustments are made according to physiological motion.

15. A system for flexible rate processing of ultrasound data comprising:
a data acquisition controller that collects ultrasound data at an acquisition rate;
a memory that stores the ultrasound data; and
a data processor that
selects framesets at an inter-frameset data rate, wherein a frameset is a set of frames selected from memory,
performs processing on a frameset, and
outputs processed data at a product rate.

16. The method of claim 15, wherein the memory is a buffer that temporarily stores the ultrasound data.

17. The system of claim 15, wherein the processing on a frameset is speckle tracking.

18. The system of claim 15, wherein the processor selects frames of a frameset at an intra-frameset data rate.

19. The system of claim 18, wherein the frames of a frameset are consecutive.

20. The system of claim 15, wherein the inter-frameset data rate and the intra-frameset data rate are dynamically adjusted according to physiological motion.
